(19) United States
(12) Patent Application Publication
(10) Pub. No.: US 2008/0057350 A1
(43) Pub. Date: Mar. 6, 2008

(54) Magnetic media and sputter targets with compositions of high anisotropy alloys and oxide compounds

(75) Inventors: Anirban Das, Chandler, AZ (US); Michael Gene Racine, Phoenix, AZ (US); Steven Roger Kennedy, Chandler, AZ (US)

Correspondence Address: MCDERMOTT WILL & EMERY LLP, 18191 VON KARMAN AVE., SUITE 500, IRVINE, CA, 92612-7108, US

(73) Assignee: Heraeus, Inc., Chandler, AZ (US)

(21) Appl. No.: 11/514,175

(22) Filed: Sep. 1, 2006

(51) Int. Cl. G11B 5/65

(52) U.S. Cl. 428/836.2

(57) ABSTRACT

A magnetic data storage layer includes a high-Kᵤ alloy and an oxide compound of oxygen and either a single element or an alloy. Because of their high Kᵤ, the magnetic domains of this magnetic data storage layer can be made significantly smaller, while maintaining an acceptable thermal stability ratio of about 50 to 70, to provide areal densities of greater than 200 Gb/in². Sputter targets for sputtering such a magnetic data storage layer are also provided. The sputter targets include the high-Ku alloy and either the desired oxide compounds, or the elements to be oxidized in a reactive sputtering process. The high-Kᵤ alloy has an anisotropy constant of at least 0.5×10⁷ ergs/cm³.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to magnetic recording media and, more particularly, to magnetic recording media having magnetic data storage layers with high areal densities, as well as sputter targets for producing such magnetic data storage layers.

### BACKGROUND OF THE INVENTION

To increase the areal density of a magnetic recording medium, the size of individual magnetic domains in a storage layer of the medium must be scaled down. This may be accomplished by achieving lower grain sizes in the magnetic storage layer. To maintain an acceptable thermal stability ratio in each magnetic domain as the size thereof is reduced, it is desirable to use materials with high anisotropy constants.

Accordingly, there is a need to provide magnetic recording media with smaller magnetic domains and acceptable thermal stability ratios, as well as sputter targets for forming such magnetic recording media. The present invention satisfies these needs and provides other advantages as well.

### SUMMARY OF THE INVENTION

In accordance with the present invention, a magnetic data storage layer includes a high-Kᵤ alloy and an oxide compound (of oxygen and either a single element or an alloy). Because of their high Kᵤ, the magnetic domains of this magnetic data storage layer can be made significantly smaller, while maintaining an acceptable thermal stability ratio of about 50 to 70, to provide areal densities of greater than 200 Gb/in². Sputter targets for sputtering such a magnetic data storage layer are also provided. The sputter targets include the high-Kᵤ alloy and either the desired oxide compounds, or the elements to be oxidized in a reactive sputtering process.

According to one embodiment of the present invention, a magnetic recording medium has a magnetic data storage layer which includes a first alloy having an anisotropy constant of at least 0.5×10⁷ ergs/cm³ and an oxide compound of oxygen and one or more elements, at least one of the one or more elements having a negative reduction potential.

According to another embodiment of the present invention, a sputter target includes a first alloy having an anisotropy constant of at least 0.5×10⁷ ergs/cm³ and an oxide compound of oxygen and one or more elements, at least one of the one or more elements having a negative reduction potential.

According to another embodiment of the present invention, a sputter target includes a first alloy having an anisotropy constant of at least 0.5×10⁷ ergs/cm³ and a second material including one or more elements, at least one of the one or more elements having a negative reduction potential.

It is to be understood that both the foregoing summary of the invention and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1A illustrates a magnetic recording medium according to one embodiment of the present invention;

FIG. 1B illustrates a magnetic data storage layer according to one aspect of the present invention;

FIG. 2 illustrates a sputter target according to another embodiment of the present invention; and

FIG. 3 illustrates a sputter target being sputtered to generate a film according to one aspect of the present invention.

### DETAILED DESCRIPTION OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

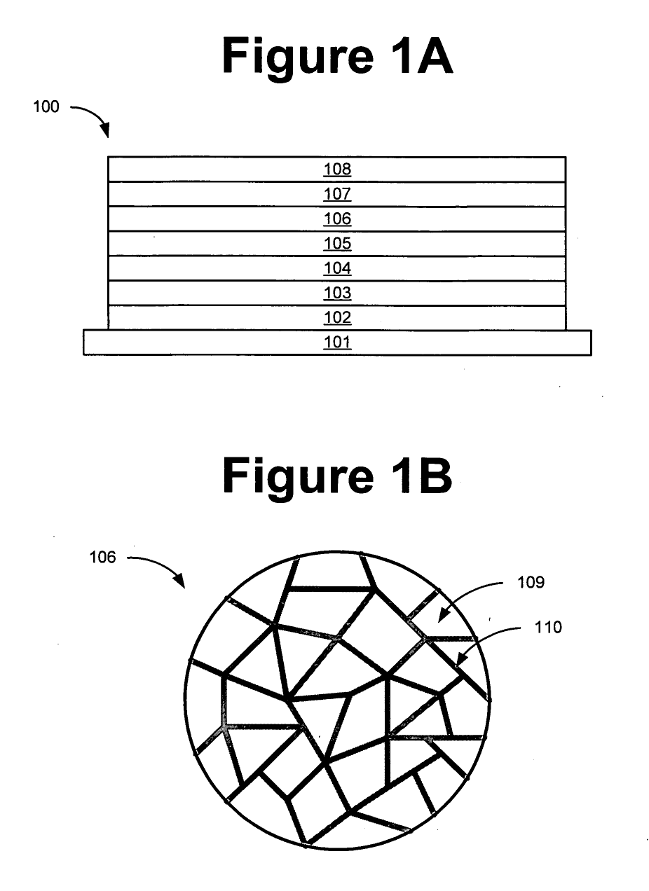

FIG. 1A illustrates a magnetic recording media stack 100 according to one embodiment of the present invention. Magnetic recording media stack 100 includes a substrate 101 (e.g., glass or aluminum), a seed layer 104, an underlayer 105 and a magnetic data storage layer 106. Magnetic recording media stack 100 may also include one or more soft underlayers with or without other non-magnetic or magnetic layers, such as layers 102 and 103, disposed on substrate 101. Magnetic recording media stack 100 may further include a lube layer and a carbon overcoat with or without other magnetic or non-magnetic layers, such as layers 107 and 108.

FIG. 1B illustrates magnetic data storage layer 106 in further detail. Magnetic data storage layer 106 is made up of two different materials, one of which is an oxide compound for refining the grain size of magnetic data storage layer 106, the other of which has a high anisotropy constant Kᵤ to ensure an acceptable thermal stability ratio.

The presence of the oxide compound acts to refine the grain size of magnetic data storage layer 106. This occurs as a result of the oxide compound being disposed in oxide-rich grain boundary phases 110, which act to separate the magnetic grains 109 of the high-Kᵤ material, thereby contributing to the effective exchange decoupling of magnetic domains and an improved signal-to-noise ratio (“SNR”).

According to one aspect, the oxide compound is a compound of oxygen and a single element with a negative reduction potential. According to another aspect, the oxide compound is a compound of oxygen and multiple elements, at least one of which has a negative reduction potential. Table 1, below, illustrates a number of metals and metalloids with negative reduction potentials that are suitable for use as an oxide in a magnetic data storage layer of the present invention.

TABLE 1

| | Reduction | | Reduction |
|---|---|---|---|
| Element | Potential (eV) | Element | Potential (eV) |
| Li | −3.04 | Cd | −0.4025 |
| Be | −1.97 | In | −0.33 |
| B | −0.89 | Cs | −2.923 |
| Na | −2.713 | Ba | −2.92 |
| Mg | −2.356 | La | −2.38 |
| Al | −1.676 | Ce | −2.34 |
| Si | −0.909 | Pr | −2.35 |
| K | −2.925 | Nd | −2.32 |
| Ca | −2.84 | Sm | −2.3 |
| Sc | −2.03 | Eu | −1.99 |
| Ti | −0.86 | Tb | −2.31 |
| V | −0.236 | Gd | −2.28 |
| Cr | −0.74 | Ho | −2.33 |
| Fe | −0.04 | Er | −2.32 |
| Fe | −0.44 | Tm | −2.32 |
| Co | −0.28 | Yb | −2.22 |
| Ni | −0.257 | Lu | −2.3 |
| Zn | −0.792 | Hf | −1.7 |
| Ga | −0.53 | Ta | −0.81 |
| Rb | −2.924 | W | −0.09 |
| Sr | −2.89 | Pb | −0.125 |
| Y | −2.37 | Th | −1.83 |
| Zr | −1.55 | U | −1.38 |
| Nb | −0.65 | | |

The thermal stability ratio for the magnetic domains of magnetic data storage layer 106 is given by Equation 1:

KᵤV/k_{B}T (1)

where Kᵤ is the anisotropy constant of the material of the magnetic domain, V is the size of the magnetic domain, k_{B} is the Boltzmann constant, and T is the temperature of the magnetic domain in degrees Kelvin. As can be seen with reference to Equation 1, as the size V of a magnetic domain decreases, the anisotropy constant Kᵤ must be increased to maintain the same thermal stability ratio. Accordingly, the high-Kᵤ material permits the magnetic domains of magnetic data storage layer 106 to maintain an acceptable thermal stability ratio of about 50 to 70 as the size of the magnetic domains is reduced.

According to one aspect, the high-Kᵤ material has an anisotropy constant of at least 0.5×10⁷ ergs/cm³. For example, the high-Kᵤ material may be chosen from materials such as L1₀-type ordered intermetallics, ordered HCP intermetallics, and rare earth transition metal alloys. Table 2, below, illustrates a number of materials with high anisotropy constants that are suitable for use as a first material in a magnetic data storage layer of the present invention.

TABLE 2

| Alloy System | Material | Kᵤ (10⁷ergs/cm³) |
|---|---|---|
| L1₀-type ordered intermetallics | FePd | 1.8 |
| | FePt | 6.6–10 |
| | CoPt | 4.9 |
| | MnAl | 1.7 |
| Ordered HCP intermetallics | Co₃Pt | 2.0 |
| Rare earth transition metal alloys | Fe₁₄Nd₂B | 4.6 |
| | SmCo₅ | 11–20 |

While magnetic recording media stack 100 has been described with reference to a particular arrangement of layers, it will be apparent to one of skill in the art that the scope of the present invention is not limited to such an arrangement. Rather, the present invention has application to magnetic recording media which include more or less layers than magnetic recording media stack 100, and which are disposed in any arrangement known to those of skill in the art.

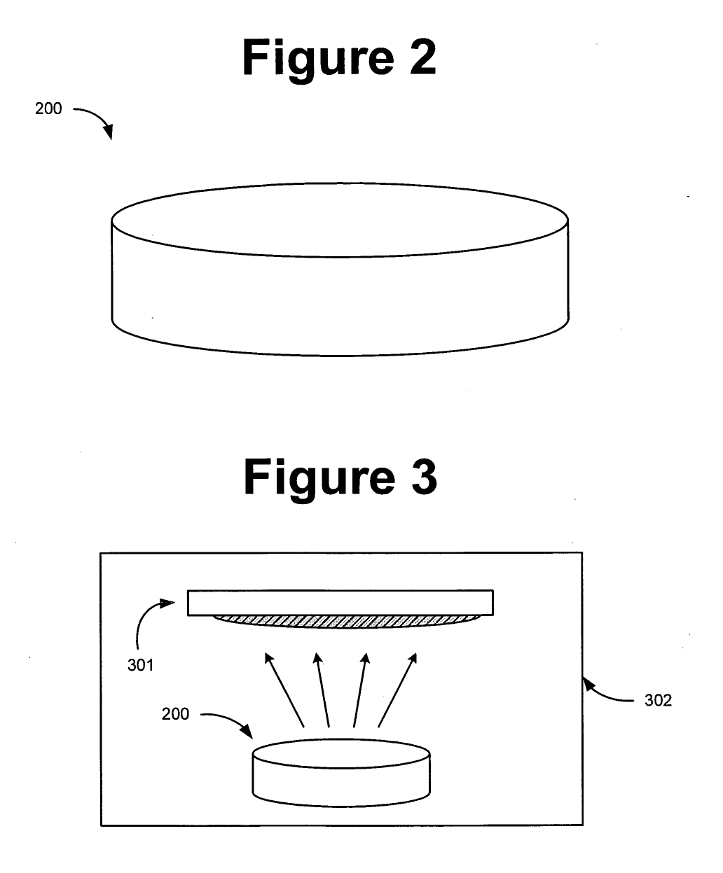

Turning to FIG. 2, a sputter target 200 is illustrated according to one embodiment of the present invention. Sputter target 200 may be used to sputter a film such as magnetic data storage layer 106. According to one embodiment of the present invention, sputter target 200 is made up of two different materials, one of which is an oxide compound (e.g., an oxide of one or more of the elements listed in Table 1) for refining the grain size of a magnetic data storage layer sputtered therefrom, the other of which has a high anisotropy constant Kᵤ (e.g., one of the alloys listed in Table 2) to ensure an acceptable thermal stability ratio in a magnetic data storage layer sputtered therefrom. According to one aspect, these two materials are combined in sputter target 200 as a single alloy. According to alternate aspects, these two materials may be provided as separate regions of sputter target 200, or combined in any one of a number of other ways readily apparent to those of skill in the art.

According to another embodiment of the present invention, in which sputter target 200 is used to reactively sputter, in the presence of oxygen, a film such as magnetic data storage layer 106, sputter target 200 does not include an oxide compound. Rather, in addition to a high-Kᵤ material (e.g., one of the alloys listed in Table 2), sputter target 200 includes a second material made up of one or more elements, at least one of which has a negative reduction potential (e.g., one or more of the elements listed in Table 1). This second material will combine with oxygen during the reactive sputtering process to provide the oxide compound for refining the grain size of a magnetic data storage layer reactively sputtered therefrom. According to one aspect, these two materials are combined in sputter target 200 as a single alloy. According to alternate aspects, these two materials may be provided as separate regions of sputter target 200, or combined in any one of a number of other ways readily apparent to those of skill in the art.

FIG. 3 illustrates sputter target 200 being sputtered to generate a film 300 on a substrate 301 according to one aspect of the present invention. In the sputtering process, sputter target 200 is positioned in a sputtering chamber 302, which is partially filled with an inert gas. Sputter target 200 is exposed to an electric field to excite the inert gas to generate plasma. Ions within plasma collide with a surface of sputter target 200 causing molecules to be emitted from the surface of sputter target 200. A difference in voltage between sputter target 200 and substrate 301 causes the emitted molecules to form the desired film 300 on the surface of substrate 301.

According to another aspect of the present invention, in which sputter target 200 is reactively sputtered in the presence of oxygen, sputtering chamber 302 is partially filled with both an inert gas and oxygen. Sputter target 200 is exposed to an electric field to excite both gas species to generate plasma. Some of the negative reduction potential elements which have been ejected off of sputter target 200 chemically react with oxygen in the plasma to form oxide compounds, which are deposited in film 300 on the surface of substrate 301.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention.

What is claimed is:

1. A magnetic recording medium having a magnetic data storage layer, the magnetic data storage layer comprising:
a first alloy having an anisotropy constant of at least 0.5×10⁷ ergs/cm³; and
an oxide compound of oxygen and one or more elements, at least one of the one or more elements having a negative reduction potential.

2. The magnetic recording medium of claim 1, wherein the first alloy is selected from the group consisting of L1₀-type ordered intermetallics, ordered HCP intermetallics, and rare earth transition metal alloys.

3. The magnetic recording medium of claim 1, wherein the oxide compound is disposed in oxide-rich grain boundaries separating magnetic grains of the first alloy.

4. The magnetic recording medium of claim 1, wherein the first alloy is selected from the group consisting of FePt, FePd, CoPt, MnAl, Co₃Pt, SmCo₅ and Fe₁₄Nd₂B.

5. The magnetic recording medium of claim 1, wherein at least one of the one or more elements in the oxide compound is a metal or a metalloid.

6. The magnetic recording medium of claim 1, wherein at least one of the one or more elements in the oxide compound is selected from the group consisting of lithium (Li), beryllium (Be), boron (B), sodium (Na), magnesium (Mg), aluminum (Al), silicon (Si), potassium (K), calcium (Ca), scandium (Sc), titanium (Ti), vanadium (V), chromium (Cr), manganese (Mn), iron (Fe), cobalt (Co), nickel (Ni), zinc (Zn), gallium (Ga), rubidium (Rb), strontium (Sr), yttrium (Y), zirconium (Zr), niobium (Nb), cadmium (Cd), indium (In), cesium (Cs), barium (Ba), lanthanum (La), cerium (Ce), praseodymium (Pr), neodymium (Nd), samarium (Sm), europium (Eu), terbium (Th), gadolinium (Gd), holmium (Ho), erbium (Er), thulium (Tm), ytterbium (Yb), lutetium (Lu), hafnium (Hf), tantalum (Ta), tungsten (W), lead (Pb), thorium (Th) and uranium (U).

7. A sputter target comprising a first alloy having an anisotropy constant of at least 0.5×10⁷ ergs/cm³, and an oxide compound of oxygen and one or more elements, at least one of the one or more elements having a negative reduction potential.

8. The sputter target of claim 7, wherein the first alloy and the oxide compound are alloyed.

9. The sputter target of claim 7, wherein the first alloy is selected from the group consisting of L1₀-type ordered intermetallics, ordered HCP intermetallics, and rare earth transition metal alloys.

10. The sputter target of claim 7, wherein the first alloy is selected from the group consisting of FePt, FePd, CoPt, MnAl, Co₃Pt, SmCo₅ and Fe₁₄Nd₂B.

11. The sputter target of claim 7, wherein at least one of the one or more elements in the oxide compound is a metal or a metalloid.

12. The sputter target of claim 7, wherein at least one of the one or more elements in the oxide compound is selected from the group consisting of lithium (Li), beryllium (Be), boron (B), sodium (Na), magnesium (Mg), aluminum (Al), silicon (Si), potassium (K), calcium (Ca), scandium (Sc), titanium (Ti), vanadium (V), chromium (Cr), manganese (Mn), iron (Fe), cobalt (Co), nickel (Ni), zinc (Zn), gallium (Ga), rubidium (Rb), strontium (Sr), yttrium (Y), zirconium (Zr), niobium (Nb), cadmium (Cd), indium (In), cesium (Cs), barium (Ba), lanthanum (La), cerium (Ce), praseodymium (Pr), neodymium (Nd), samarium (Sm), europium (Eu), terbium (Th), gadolinium (Gd), holmium (Ho), erbium (Er), thulium (Tm), ytterbium (Yb), lutetium (Lu), hafnium (Hf), tantalum (Ta), tungsten (W), lead (Pb), thorium (Th) and uranium (U).

13. A film sputtered from the sputter target of claim 7, wherein the oxide compound is disposed in the film within oxide-rich grain boundaries separating magnetic grains of the first alloy.

14. A sputter target comprising a first alloy having an anisotropy constant of at least 0.5×10⁷ ergs/cm³, and a second material including one or more elements, at least one of the one or more elements having a negative reduction potential.

15. The sputter target of claim 14, wherein the first alloy and the second material are alloyed.

16. The sputter target of claim 14, wherein the first alloy is selected from the group consisting of L1₀-type ordered intermetallics, ordered HCP intermetallics, and rare earth transition metal alloys.

17. The sputter target of claim 14, wherein the first alloy is selected from the group consisting of FePt, FePd, CoPt, MnAl, Co₃Pt, SmCo₅ and Fe₁₄Nd₂B.

18. The sputter target of claim 14, wherein at least one of the one or more elements in the oxide compound is a metal or a metalloid.

19. The sputter target of claim 14, wherein at least one of the one or more elements in the oxide compound is selected from the group consisting of lithium (Li), beryllium (Be), boron (B), sodium (Na), magnesium (Mg), aluminum (Al), silicon (Si), potassium (K), calcium (Ca), scandium (Sc), titanium (Ti), vanadium (V), chromium (Cr), manganese (Mn), iron (Fe), cobalt (Co), nickel (Ni), zinc (Zn), gallium (Ga), rubidium (Rb), strontium (Sr), yttrium (Y), zirconium (Zr), niobium (Nb), cadmium (Cd), indium (In), cesium (Cs), barium (Ba), lanthanum (La), cerium (Ce), praseodymium (Pr), neodymium (Nd), samarium (Sm), europium (Eu), terbium (Th), gadolinium (Gd), holmium (Ho), erbium (Er), thulium (Tm), ytterbium (Yb), lutetium (Lu), hafnium (Hf), tantalum (Ta), tungsten (W), lead (Pb), thorium (Th) and uranium (U).

20. A film reactively sputtered from the sputter target of claim 14 in the presence of oxygen, wherein oxides of the second material are disposed in the film within oxide-rich grain boundaries separating magnetic grains of the first alloy.
